(19) United States
(12) Patent Application Publication
(10) Pub. No.: US 2019/0193741 A1
(43) Pub. Date: Jun. 27, 2019

(54) ANOMALY DETECTION METHOD AND APPARATUS

(71) Applicants: DENSO CORPORATION, Kariya-city (JP); NATIONAL UNIVERSITY CORPORATION NARA INSTITUTE OF SCIENCE AND TECHNOLOGY, Ikoma (JP)

(72) Inventors: Kentaro HITOMI, Kariya-city (JP); Kazuhito TAKENAKA, Kariya-city (JP); Masataka MORI, Kariya-city (JP); Kazushi IKEDA, Ikoma (JP); Takatomi KUBO, Ikoma (JP); Hiroaki SASAKI, Ikoma (JP)

(21) Appl. No.: 16/227,465

(22) Filed: Dec. 20, 2018

(30) Foreign Application Priority Data
Dec. 22, 2017 (JP) 2017-246819

(51) Int. Cl. B60W 40/06; G06K 9/00; H04W 4/46; G08G 1/0967

(52) U.S. Cl. CPC B60W 40/06; G08G 1/096791; H04W 4/46; G06K 9/00791

(57) ABSTRACT

In an apparatus for detecting an anomaly of an evaluation target condition of a road, a storage stores a reference data set correlating to a predetermined attribute and being comprised of reference data samples. An anomaly level calculator obtains, from target vehicles, an evaluation data set correlating to the predetermined attribute and being comprised of evaluation data samples. The evaluation data samples are collected from the respective target vehicles as target driving data items at the predetermined attribute under the evaluation target condition of the road. The target driving data item for each of the target vehicles represents at least one driving operation of the corresponding one of the target vehicles. The anomaly level calculator compares the reference data set with the evaluation data set to thereby calculate an anomaly level of the evaluation target condition of the road.

### CROSS REFERENCE TO RELATED APPLICATION

This application is based on and claims the benefit of priority from Japanese Patent Application No. 2017-246819 filed on Dec. 22, 2017, the disclosure of which is incorporated in its entirety herein by reference.

### TECHNICAL FIELD

The present disclosure relates to technologies for detecting the anomaly, i.e. defective level, of a road.

### BACKGROUND

Japanese Patent Application Publication No. 2016-118906 discloses an anomaly detection apparatus capable of detecting the anomaly of a road even if no infrastructural sensors, such as road monitor cameras, are installed around the road for monitoring the road condition. The anomaly detection apparatus disclosed in the published patent document includes a normal driving model. The normal driving model is comprised of many driving pattern data items collected from many normally travelling vehicles; each of the driving pattern data items correlates with a corresponding road section to be collected.

When each target vehicle is travelling on a road section, the anomaly detection apparatus collects driving pattern data items and the currently travelling road section from each target vehicle. Then, the anomaly detection apparatus compares the collected driving pattern data items of each target vehicle with the normal driving model at the same road section. Based on the compared results, the anomaly detection apparatus obtains deviation of the driving pattern data items of each target vehicle from the normal driving model, thus detecting a deviation of the driving pattern data items of each target vehicle from the normal driving model as the anomaly of the conditions of the road on which each target vehicle is travelling.

### SUMMARY

If a driver of a vehicle is able to find out the abnormality of the travelling road condition earlier, the driver can drive the vehicle within a driver's normal driving behavior range to thereby address the abnormality of the travelling road condition. For example, if a driver of a vehicle is able to visibly recognize, from a distance, an obstacle located on a travelling lane of a road, the driver changes the travelling lane to another, making it possible to avoid the obstacle.

Even if a driver of a vehicle is able to drive the vehicle within a driver's normal driving range, an in-vehicle device is preferably capable of accurately detecting the anomaly of the conditions of a travelling road.

Unfortunately, if the driver's driving action of each vehicle for addressing the abnormality of the conditions of a travelling road is within a driver's normal driving range, a deviation of the driving pattern data items of each vehicle from the normal driving model may be smaller. This may make it difficult for the above anomaly detection apparatus to detect the abnormality of the conditions of the road accurately.

In view of the circumstances set forth above, an aspect of the present disclosure seeks to provide anomaly detection apparatuses and methods, each of which is capable of detecting the anomaly of a road condition more accurately.

According to a first exemplary aspect of the present disclosure, there is provided an apparatus for detecting an anomaly of an evaluation target condition of a road.

The apparatus according to the first exemplary aspect includes a storage that stores a reference data set correlating to a predetermined attribute and being comprised of reference data samples. The reference data samples have been respectively collected from reference vehicles as reference driving data items at the predetermined attribute under a normal condition of the road. The reference driving data item for each of the reference vehicles represents at least one driving operation of the corresponding one of the reference vehicles. The apparatus includes an anomaly level calculator configured to obtain, from target vehicles, an evaluation data set correlating to the predetermined attribute and being comprised of evaluation data samples. The evaluation data samples are collected from the respective target vehicles as target driving data items at the predetermined attribute under the evaluation target condition of the road. The target driving data item for each of the target vehicles represents at least one driving operation of the corresponding one of the target vehicles. The anomaly level calculator is configured to compare the reference data set with the evaluation data set to thereby calculate a degree of an anomaly of the evaluation target condition of the road.

According to a second exemplary aspect of the present disclosure, there is provided a method of detecting an anomaly of an evaluation target condition of a road.

The method according to the first exemplary aspect includes

(1) Preparing a data set correlating to a predetermined attribute and being comprised of reference data samples, the reference data samples having been respectively collected from reference vehicles as reference driving data items at the predetermined attribute under a normal condition of the road, the reference driving data item for each of the reference vehicles representing at least one driving operation of the corresponding one of the reference vehicles

(2) Obtaining, from target vehicles, an evaluation data set correlating to the predetermined attribute and being comprised of evaluation data samples, the evaluation data samples being collected from the respective target vehicles as target driving data items at the predetermined attribute under the evaluation target condition of the road, the target driving data item for each of the target vehicles representing at least one driving operation of the corresponding one of the target vehicles

(3) Comparing the reference data set with the evaluation data set to thereby calculate a degree of an anomaly of the evaluation target condition of the road.

Each of the first and second exemplary aspects is configured to perform comparison between

(1) The reference data set, which has been collected from reference vehicles as reference driving data items at a predetermined attribute under a normal condition of the road

(2) The evaluation data set, which are collected from respective target vehicles as target driving data items at the predetermined attribute under the evaluation target condition of the road

When it is assumed that there is an anomaly in the evaluation target condition of the road, a driver's selectable driving-action range is limited as compared with a case where there are no anomaly in the evaluation target condition of the road, i.e. a normal condition of the road although a driver of each of the target vehicles can perform a normal driving action.

From this viewpoint, because the reference data set is comprised of the reference data samples that have been respectively collected from the reference vehicles as the reference driving data items at the predetermined attribute under a normal condition of the road, the reference data set shows a driver's normal driving action range. In addition, because the evaluation data set is comprised of evaluation data samples that are collected from the respective target vehicles as the target driving data items at the predetermined attribute under the evaluation target condition of the road, the evaluation data set shows a driver's selectable driving action range.

This therefore results in a difference between the reference data set and the evaluation data set. Accordingly, comparing the reference data set with the evaluation data set enables the anomaly of the evaluation target condition of the road to be properly detected even if the driver's action of each target vehicle is within a normal driving action range.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an anomaly detection apparatus according to the first embodiment of the present disclosure;

FIG. 2 is a flowchart schematically illustrating an anomaly detection routine according to the first embodiment;

FIG. 3 is a diagram schematically illustrates driving actions if there are no abnormalities in a road condition;

FIG. 4 is a diagram schematically illustrating driving actions if fallen rocks are located on the left lane of a road, so that there is an abnormality in the road condition; and

FIG. 5 is a block diagram schematically illustrating an anomaly calculator according to the second embodiment of the present disclosure.

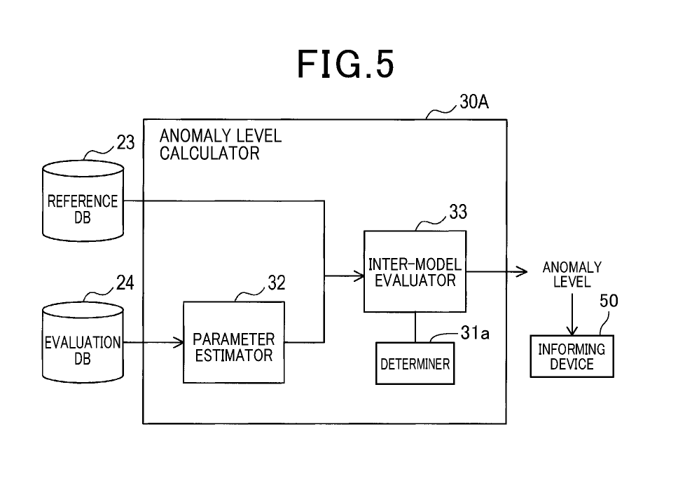

### DETAILED DESCRIPTION OF EMBODIMENT

The following describes embodiments of the present disclosure with reference to the accompanying drawings. In the embodiments, like parts between the embodiments, to which like reference characters are assigned, are omitted or simplified to avoid redundant description.

### First Embodiment

### Structure

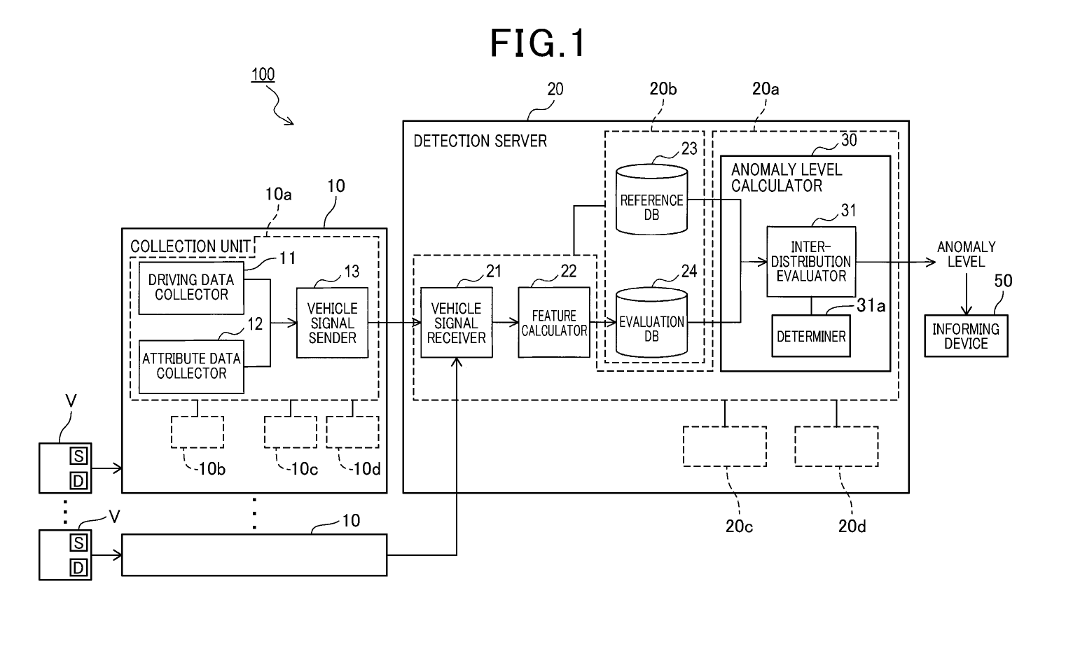

FIG. 1 is a block diagram illustrating a schematic structure of an anomaly detection apparatus 100 according to the first embodiment of the present disclosure.

The anomaly detection apparatus, i.e. abnormality detection apparatus, 100 includes a plurality of collection units 10, a detection server 20, and an informing device 50.

Each of the collection units 10 is configured as an in-vehicle device. The in-vehicle device is mainly comprised of a computer including a processor, i.e. CPU, 10a, a memory 10b comprised of, for example, a RAM and a ROM, an I/O interface 10c, and a radio communicator 10d; the ROM is an example of a non-transitory storage medium. The collection units 10 are respectively installed in vehicles V.

Each of the collection units 10 is configured to wirelessly communicate with the detection server 20.

The CPU 10a runs one or more programs stored in, for example, the ROM of the memory 10b, thus implementing the functions of respective driving data collector 11, an attribute data collector 12, and a vehicle signal sender 13. In other words, the CPU 10a functionally includes the driving data collector 11, attribute data collector 12, and vehicle signal sender 13. At least part or the whole of each of the functional modules 11, 12, and 13 can be implemented as a hardware circuit or a hardware/software hybrid circuit.

Each driving data collector 11 installed in the corresponding vehicle V includes various sensors S. Each driving data collector 11 repeatedly collects driving data items, i.e. driving information items, repeatedly sent from the sensors S.

The driving data items include driving operation data items about driver's operations of the corresponding vehicle V, and vehicle behavior data item monitored by the sensors installed to the corresponding vehicle V.

The driving operation data items include, for example,

(1) The operated quantity of an accelerator pedal of the corresponding vehicle V operated by a driver of the corresponding vehicle V, i.e. the operated quantity of a throttle valve of the corresponding vehicle V linked to the accelerator pedal

(2) The operated quantity of a brake pedal of the corresponding vehicle V operated by a driver of the corresponding vehicle V

(3) The steering angle of the corresponding vehicle V operated by the driver of the corresponding vehicle V

(4) The shifted position of a transmission of the corresponding vehicle V operated by the driver of the corresponding vehicle V

(5) The working conditions of indicators of the corresponding vehicle V operated by the driver of the corresponding vehicle V

The vehicle behavior data items include, for example, the speed, i.e. vehicle speed, of the corresponding vehicle V, the acceleration of the corresponding vehicle V, and the yaw rate of the corresponding vehicle V.

Each attribute data collector 12 installed in the corresponding vehicle V includes various in-vehicle devices, such as sensors and communication devices, D. Each attribute data collector 12 repeatedly collects attribute data items, i.e. attribute information items, repeatedly sent from the in-vehicle devices D.

The attribute data items include data items each indicative of an attribute to which at least one of the driving data items belong. In other words, the attribute data items include data items each indicative of an attribute with which at least one of the driving data items correlates.

That is, the attribute data items include, for example, time data items, position data items, weather data items, and vehicle type data items.

The time data items include, for example, the collection time and day of week for each of the driving data items. The position data items include, for example, the latitude and longitude of the current position of the corresponding vehicle V for each of the driving data items; the latitude and longitude of the current position of the corresponding vehicle V are obtained based on global positioning system (GPS) signals, which are sent from GPS satellites, received by a GPS receiver installed in the corresponding vehicle V as one of the in-vehicle devices D.

The weather data items include, for example, the current weather condition, such as a fine condition or a rain condition, around the corresponding vehicle V for each of the driving data items, which is sent from a weather center and received by a communication device as one of the in-vehicle devices D. The weather data items also include, for example, the amount of rainfall at the present time measured by a sensor as one of the in-vehicle devices D, and the amount of insolation at the present time measured by a sensor as one of the in-vehicle devices D. The vehicle type data items include, for example, the type and size class of the corresponding vehicle V, and a predetermined displacement volume of the corresponding vehicle V.

Note that each attribute information collector 12 does not necessarily collect all the above attribute data items, and can collect at least part of the above attribute date items.

The vehicle signal sender 13 is configured to

(1) Correlate each of the driving data items collected by the driving data collector 10 with at least one of the attribute data items collected by the attribute data collector 11 to thereby generate vehicle signals each including the set of driving information data items and a corresponding attribute data item

(2) Send the vehicle signals to the detection server 20 via the radio communications with the detection server 20

The detection server 20 is mainly comprised of a computer including a processor, i.e. CPU, 20a, a memory 20b comprised of, for example, a RAM and a ROM, an I/O interface 20c, and a radio communicator 20d; the ROM is an example of a non-transitory storage medium. The detection server 20 is for example installed in an information center. The CPU 20a of the detection server 20 runs one or more programs stored in the ROM of the memory 20b, thus implementing the functions of a vehicle signal receiver 21, a feature calculator 22, and an anomaly level calculator 30. At least part or the whole of each of the functional modules 21, 22, and 30 can be implemented as a hardware circuit or a hardware/software hybrid circuit.

The detection server 20 also includes a reference database (DB) 23 and an evaluation DB 24.

The detection server 20 is configured to implement the above functions 21, 22, and 30 to thereby detect an anomaly, i.e. an abnormality, of the conditions of a road on which each vehicle V is travelling. That is, the detection server 20 serves as an anomaly detector. The informing device 50 includes, for example, at least one of a visible output device, such as a display on the dashboard panel, and an audible output device, such as a speaker. The informing device 50 is configured to provide, to members of the information center, visible and/or audible information. The informing device 50 can be configured to instruct the CPU 10a of each vehicle V to provide, to a driver of the corresponding vehicle V, visible and/or audible information.

### Anomaly Detection Routine

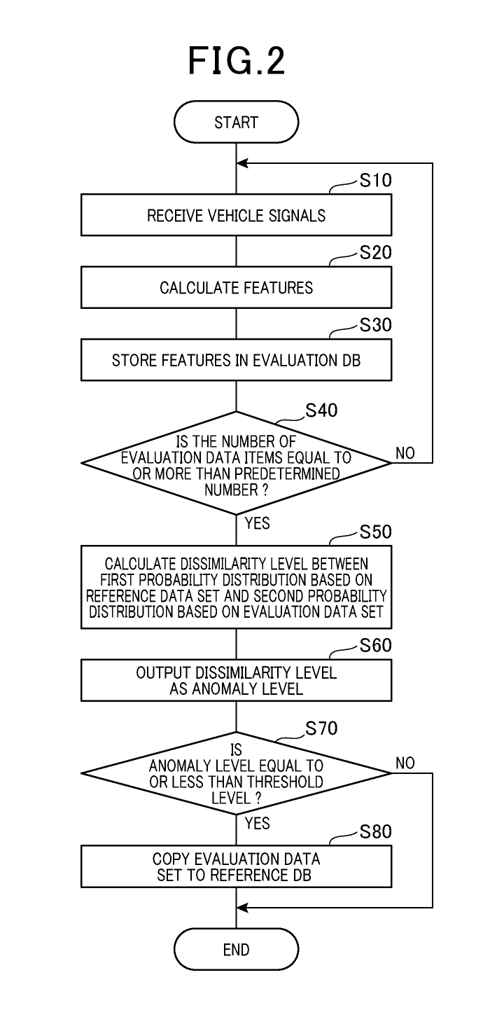

The following schematically describes, with reference to the flowchart of FIG. 2, an anomaly detection routine carried out by the detection server 20. In particular, the CPU 20a of the detection server 20 executes the anomaly detection routine in a predetermined processing period. Hereinafter, one anomaly detection routine periodically performed by the CPU 20a will be referred to as a cycle.

Upon starting a current cycle of the anomaly detection routine, the CPU 20a serves as, for example, the vehicle signal receiver 21 to receive the vehicle signals sent from the driving data collector 10 of each vehicle V in step S10.

Next, the CPU 20a serves as, for example, the feature calculator 22 to calculate or obtain, based on the driving data items included in each of the vehicle signals, at least one feature in step S20. For example, the at least one feature is at least one of the vehicle behavior data items, the driving operation date items, and/or processed data items, such as differential data items, obtained based on predetermined processing of these vehicle behavior data items and the driving operation date items.

Specifically, the CPU 20a calculates or obtains, as the at least one feature, the speed of each vehicle V, the acceleration of each vehicle V, the operated quantity of the acceleration pedal, the operated quantity of the brake pedal, the steering angle of each vehicle V, the operated rate of the accelerator pedal, the operated rate of the brake pedal, and/or the operated rate of the steering. Alternatively, the CPU 20a can obtain, as the at least one feature, only at least one of the vehicle behavior data items and driving operation data items of each vehicle V. The at least feature according to the first embodiment can serve as, for example, at least one driving data item.

Following the operation in step S20, the CPU 20a serves as, for example, the feature calculator 22 to store the at least one feature obtained in step S20 in the evaluation DB 24 such that the at least one feature correlates with corresponding one or more of the attribute data items in step S30. That is, the CPU 20a stores the at least one feature obtained in an anomaly unchecked road condition such that the at least one feature correlates with the corresponding one or more of the attribute data items; the anomaly unchecked road condition is an evaluation target road condition whose anomaly has not been determined yet.

Note that at least one feature obtained from the driving data items of one of the vehicles V in the anomaly unchecked road condition constitutes an evaluation data sample. That is, if plural features are obtained from the driving data items of one of the vehicles V, an evaluation data sample constitutes a multidimensional data sample including the plural features.

Note that the CPU 20a serves as, for example, the feature calculator 22 to store, in the evaluation DB 24, a large number of features obtained for each attribute data item from the collected driving data items in step S20 such that the large number of features correlates with each attribute data item while there is no anomaly in a road condition.

For example, upon determining that the evaluation target road condition is a normal road condition in which no anomaly is found described later, the CPU 20a copies the features obtained in the normal road condition and stored in the evaluation DB 24 for each attribute data item to the reference DB 23 such that the features correlate with each attribute date item.

Note that at least one feature obtained from the driving data items of one of the vehicles V in the normal road condition constitutes a reference data sample. That is, if plural features are obtained from the driving data items of one of the vehicles V in the normal road condition, a reference data sample constitutes a multidimensional data sample including the plural features. The number of multidimensions of the evaluation data sample is equal to the number of multidimensions of the reference data sample.

For a selected attribute data item, plural reference data samples corresponding to the selected attribute data item constitute a reference data set, and the reference data set shows a range of normal driving actions for the selected attribute data item. For example, for the position data item as the selected attribute data item, the reference data set is comprised of reference data samples collected from the respective vehicles V each located at a predetermined position in a road corresponding to the position data item, and the reference data set shows the normal driving actions at the predetermined position in the road corresponding to the position data item.

Note that the vehicles V from which the reference data samples have been collected are identical to the vehicles V from which the evaluation data samples have been collected, but the vehicles, i.e. reference vehicles, from which the reference data samples have been collected can be at least partly different from vehicles, i.e. target vehicles, from which the evaluation data samples have been collected.

The CPU 20a can be configured to compare each evaluation data item correlating to a selected attribute data item with the reference data set correlating to the selected attribute data item to thereby detect a relatively high anomaly level of a road condition upon determining that the evaluation data items deviate from the range of the normal driving actions shown by the reference data set. However, even if the CPU 20a compares each evaluation data item correlating to a selected attribute data item with the reference data set correlating to the selected attribute data item while there is an anomaly in the road condition, the CPU 20a may detect a relatively low anomaly level of the road condition, because each evaluation data item is within the range of the normal driving actions.

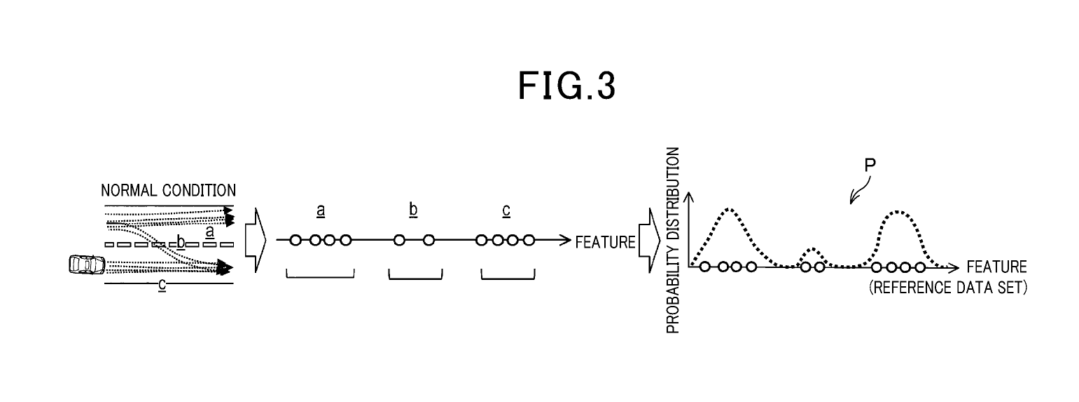

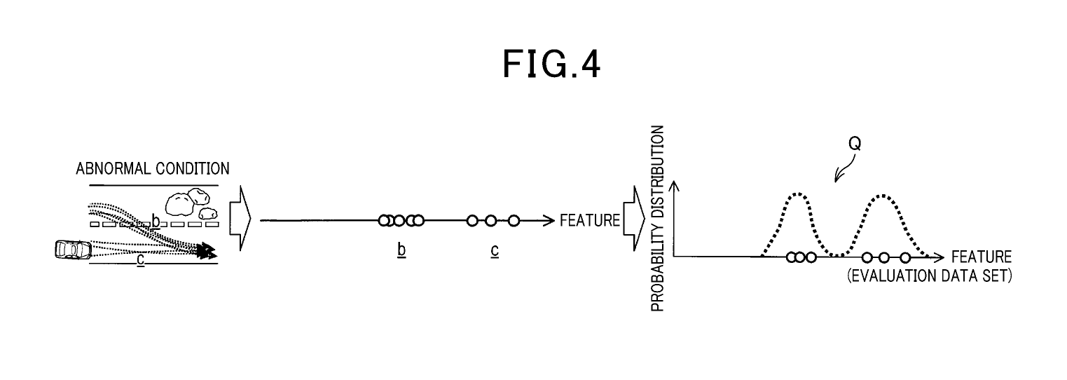

FIG. 3 schematically illustrates driving actions if there are no anomaly in a road condition, i.e. a normal condition. In contrast, FIG. 4 schematically illustrates driving actions if fallen rocks are located on the left lane of a road, so that there is an anomaly in the road condition. In each of FIGS. 3 and 4, a white circle represents at least one feature for one of the vehicles V.

The driving actions illustrated in FIG. 3 include

(1) A driving action a of going straight in the left lane

(2) A lane change b

(3) A driving action c of going straight in the right lane

In contrast, the driving actions illustrated in FIG. 4 include

(1) The lane change b

(2) The driving action c of going straight in the right lane

As illustrated in FIG. 4, if a driver of a vehicle that is travelling on the left lane finds the fallen rocks earlier, the driver causes the vehicle to make a lane change b from the left lane to the right lane, making it possible to address the anomaly of the road.

That is, if a driver of a vehicle visibly recognizes an anomaly of a road condition, the driver is able to perform a driving action within the range of normal driving actions to address the anomaly without performing a particular driving action, such as a sudden braking or a sudden turning of a steering wheel, which deviates from the range of the normal driving actions. This case may result in each evaluation data item being within the range of the normal driving actions shown by the reference data set. This therefore, even if each evaluation data item is compared with the reference data set, a relatively low anomaly level of the road may be detected.

From this viewpoint, we have focused on the following matter that, if there is an anomaly of the road condition that makes it difficult for a driver of a vehicle to perform the driving action a to go straight on the left lane in the situation illustrated in FIG. 4, a driver's selectable driving action range is limited.

The set of evaluation data items, which will be referred to as an evaluation data set, for a selected attribute data item shows a driver's selectable driving-action range in an evaluation target road condition. For this reason, as illustrated in FIGS. 3 and 4, comparing a first probability distribution P based on the reference data set belonging to a specified attribute data item, such as the position data item, with a second probability distribution Q based on the evaluation data set comprised of evaluation data items belonging to the same specified attribute data item results in a difference between the first probability distribution P and the second probability distribution Q.

Based on our discovery set forth above, the CPU 20a according to the first embodiment is specially configured to compare a reference data set for a specified attribute data item with an evaluation data set for the same specified attribute data item.

Specifically, the anomaly level calculator 30 includes an inter-distribution evaluator 31 and a determiner 31a. The distribution evaluator 31 configures at least a predetermined number of evaluation data samples for each attribute data item as an evaluation data set for the corresponding attribute data item.

Note that the number of reference data samples included in the reference data set for each attribute data item stored in the reference DB 23 is, for example, several hundred times larger than the predetermined number of evaluation data samples constituting the evaluation data set for the corresponding attribute data item.

Specifically, following the operation in step S30, the CPU 20a serves as, for example, the inter-distribution evaluator 31 to determine whether the number of evaluation data items for a selected attribute data item is equal to or more than the predetermined number in step S40.

Upon determining that the number of evaluation data items for a selected attribute data item is less than the predetermined number (NO in step S40), the CPU 20a returns to the operation in step S10, and repeatedly carries out the operations in steps S10 to S40.

Otherwise, upon determining that the number of evaluation data items for a selected attribute data item is equal to or more than the predetermined number (YES in step S40), the anomaly detection routine proceeds to step S50.

In step S50, the CPU 20a serves as, for example the inter-distribution evaluator 31 to

(1) Generate a first probability distribution P, an example of which is disclosed in FIG. 3, based on the reference data samples included in the reference data set for the specified attribute data item

(2) Generate a second probability distribution Q, an example of which is disclosed in FIG. 4, based on the evaluation data samples included in the evaluation data set for the specified attribute data item

Then, the CPU 20a serves as, for example the inter-distribution evaluator 31 to calculate a dissimilarity level, i.e. a degree of dissimilarity, between the first probability distribution P and the second probability distribution Q in step S50. FIGS. 3 and 4 show that, in the road condition including an anomaly as the evaluation road condition, the second probability distribution Q is clearly changed from the first probability distribution P, resulting in an increase in the dissimilarity level between the first and second probability distributions P and Q.

The inter-distribution evaluator 31 can be configured to generate a multidimensional space distribution as each of the first and second probability distributions P and Q if each reference data sample is a multidimensional data sample and each evaluation data sample is a multidimensional data sample. The inter-distribution evaluator 31 can also be configured to transform each multidimensional reference data sample to a single dimensional reference data sample, and each multidimensional evaluation data sample to a single dimensional evaluation data sample, and generate a single dimensional space distribution as each of the first and second probability distributions P and Q.

For example, the inter-distribution evaluator 31 according to the first embodiment is configured to calculate the dissimilarity level between the first probability distribution P and the second probability distribution Q in accordance with distances between the reference data samples and the respective evaluation data samples. For example, the inter-distribution evaluator 31 calculates a maximum mean discrepancy (MMD) indicative of the dissimilarity level between the first and second probability distributions P and Q, two-sample U statistics based on a positive semidefmite kernel function in step S50. The detailed descriptions of the two-sample U statistics are disclosed in A. Gretton, et al, “A Kemal Two-Sample Test”, Journal of Machine Learning Research, 13(Mar), pp. 72-773, 2012.

Specifically, the inter-distribution evaluator 31 calculates, as the dissimilarity level between the first and second probability distributions P and Q, two-sample U statistics Tn, m that is designed as a sample approximation of the square of the MMD in step S50. For example, the inter-distribution evaluator 31 calculates the two-sample U statistics Tn, m in accordance with the following equation (1):

$${T}_{n , m} = \frac{1}{( \begin{matrix}n \\ 2\end{matrix} ) ( \begin{matrix}m \\ 2\end{matrix} )} {Σ}_{α1 \neq α2} {Σ}_{β1 \neq β2} ( k ( {X}_{α1} , {X}_{α2} ) + k ( {Y}_{β1} , {Y}_{β2} ) - \frac{1}{2} \{ k ( {X}_{α1} , {Y}_{β1} ) + k ( {X}_{α1} , {Y}_{β2} ) + k ( {X}_{α2} , {Y}_{β1} ) + k ( {X}_{α2} , {Y}_{β2} ) \} ) \qquad ( 1 )$$

where:

(1) α1, α2, β1, and β2 are each a valuable

(2) X={X₁, . . . , Xₙ} represents the reference data set

(3) Y={Y₁, . . . , Yₘ} represents the evaluation data set

(4) n represents the size of the reference data set, i.e. the number of reference data samples included in the reference data set

(5) m represents the size of the evaluation data set, i.e. the number of evaluation data samples included in the evaluation data set

(6) k represents a two-variable kernel function

Following the operation in step S50, the CPU 20a serves as, for example, the inter-distribution evaluator 31 to output the dissimilarity level calculated in step S50 to the informing device 50 as an anomaly level of the evaluation target road condition in step S60. The informing device 50 is configured to provide, to the members of the information center, visible and/or audible information indicative of the anomaly level of the evaluation target road condition.

That is, the anomaly level of the evaluation target road condition becomes larger when the drivers of the vehicles V not only perform driving actions deviating from the range of the normal driving actions but also perform driving actions within the range of the normal driving actions as long as the distribution of the evaluation data set is changed from the distribution of the reference data set.

Following the operation in step S60, the CPU 20a serves as, for example, the determiner 31a to determine whether the anomaly level, i.e. the abnormal level, calculated in step S50 is equal to or lower than a predetermined threshold level in step S70.

Upon determining that anomaly level calculated in step S50 is larger than the predetermined threshold level (NO in step S70), the CPU 20a terminates the current cycle of the anomaly detection routine.

Otherwise, upon determining that anomaly level calculated in step S50 is equal to or smaller than the predetermined threshold level (YES in step S70), the CPU 20a determines that the evaluation target road condition is a normal road condition in which there is no anomaly. Then, the CPU 20a copies the evaluation data set for the specified attribute data item stored in the evaluation DB 24 to the reference DB 23 in step S80, and thereafter, terminates the current cycle of the anomaly detection routine.

Note that the CPU 20a can be configured to repeat the operations in steps S10 to S80 for each attribute data item.

In step S50, the inter-distribution evaluator 31 can be configured to calculate, as the dissimilarity between the first and second probability distributions P and Q, known Kolmogorov-Smirnov statistics in place of the two-sample U statistics Tn, m.

After the operation in step S60, the CPU 20a can be configured to eliminate the predetermined number of evaluation data samples for the specified attribute data item from the evaluation DB 24. In addition, after the operation in step S60, the CPU 20a can be configured to eliminate evaluation data items from the evaluation DB 24 in chronological order each time the CPU 20a calculates new evaluation data items in step S30, thus storing the new evaluation data items in the evaluation DB 24.

### Advantageous Effects

The first embodiment described above achieves the following advantageous effects.

The anomaly detection apparatus 100 of the first embodiment is configured to compare a reference data set for a specified attribute data item with an evaluation data set for the same specified attribute data item, because there is a difference, between the reference data set and the evaluation data set, due to the anomaly level of a road condition. This configuration therefore enables, based on the compared results, the anomaly level of the road condition to be evaluated even if driver's driving actions of the respective vehicles V are each within the range of the normal driving actions.

The anomaly detection apparatus 100 is also configured to compare the first probability distribution P based on the reference data set belonging to a specified attribute data item with the second probability distribution Q based on the evaluation data set comprised of evaluation data items belonging to the same specified attribute data item. This is because an anomaly having occurred in the road condition results in a difference between the first and second probability distributions P and Q even if driver's driving actions of the respective vehicles V are each within the range of the normal driving actions.

This configuration therefore enables, based on the compared results between the first and second probability distributions P and Q, the anomaly level of the road condition to be accurately detected.

The anomaly detection apparatus 100 makes it possible to calculate the dissimilarity level, i.e. the degree of dissimilarity, between the first probability distribution P and the second probability distribution Q based on the distances between the reference data samples and the respective evaluation data samples.

This configuration therefore enables the anomaly level of the road condition to be calculated robustly even if it is difficult to accurately obtain the shape of at least one of the first and second probability distributions P and Q.

The anomaly detection apparatus 100 is configured to calculate, as the dissimilarity level between the first and second probability distributions P and Q, the two-sample U statistics Tn, m that is designed as a sample approximation of the square of the MMD. This configuration enables the anomaly detection routine including the equation (1) for calculating the two-sample U statistics Tn, m to be easily implemented in the memory 10b, because the equation (1) for calculating the two-sample U statistics Tn, m has a simpler configuration.

### Second Embodiment

### Different Point Relative to First Embodiment

Because the basic structure of the second embodiment is identical to the structure of the first embodiment, the following mainly describes the different points of the second embodiment as compared with the first embodiment, and omits or simplifies descriptions of common parts between the first and second embodiments. Because reference characters used in the second embodiment, which are identical to reference characters used in the first embodiment, respectively represent common parts, the following refers to the above descriptions of the common parts.

The detection server 20 according to the first embodiment includes the anomaly level calculator 30 including the inter-distribution evaluator 31.

In contrast, the detection server 20 according to the second embodiment includes an anomaly level calculator 30A including a parameter estimator 32 and an inter-model evaluator 33 in place of the inter-distribution evaluator 31.

Specifically, the second embodiment is different from the first embodiment in the method of calculating the dissimilarity level between the first probability distribution P and the second probability distribution Q in step S50.

The first embodiment calculates the dissimilarity level between the first probability distribution P and the second probability distribution Q without estimating the shape of each of the first probability distribution P and the second probability distribution Q.

In contrast, the parameter estimator 32 of the second embodiment is configured to express the shape of each of the first probability distribution P and the second probability distribution Q using a corresponding statistical model. This makes it possible to estimate

(1) A finite number of parameters indicative of the statistical model of the first probability distribution P as first parameters

(2) A finite number of parameters indicative of the statistical model of the second probability distribution Q as second parameters

Note that the first and second parameters are the same type of parameters.

Specifically, the parameter estimator 32 is configured to previously estimate, from the reference data set for each attribute data item, the first parameters, and store the first parameters for each attribute data item in the reference DB 23. That is, the reference data set for each attribute data item is stored in the reference DB 23 according to the first embodiment, but the first parameters for each attribute data item are stored in the reference DB 23 according to the second embodiment.

The inter-model evaluator 33 is configured to calculate, in step S50, a dissimilarity level between a first probability model defined based on the first parameters and a second probability model defined based on the second parameters as a dissimilarity level between the first probability distribution P and the second probability distribution Q.

Specifically, the parameter estimator 32 is configured to express the first probability distribution P using a first discrete probability distribution model defined based on the first parameters, and the second probability distribution Q using a second discrete probability distribution model defined based on the second parameters. Then, the inter-model evaluator 33 is configured to calculate the dissimilarity level between the first discrete probability distribution model and the second discrete probability distribution model.

Specifically, the parameter estimator 32 is configured to express each of the first and second probability distributions P and Q using a histogram. That is, the parameter estimator 32 estimates, as the first parameters, the heights of respective normalized bins of the histogram of the first probability distribution P, and also estimates, as the second parameters, the heights of respective normalized bins of the histogram of the second probability distribution Q.

Then, the inter-model evaluator 33 calculates a Kullback-Leibler divergence, referred to simply as a KL divergence, as the dissimilarity level between the histogram of the first probability distribution P and the histogram of the second probability distribution Q.

Expressing each of the first probability distribution P and the second probability distribution Q using a histogram enables the KL divergence to be represented by the following equation (2):

$$KL ( P \vert \vert Q ) = {\sum }_{i = 1}^{{N}_{B}} {P}_{i} ln \frac{{P}_{i}}{{Q}_{i}} \qquad ( 2 )$$

where:

KL (P∥Q) represents the KL divergence;

i represents an index that a random variable can take;

Pᵢ represents a probability when the random variable takes a value corresponding to the index i in the first probability distribution P; and

Qᵢ represents a probability when the random variable takes a value corresponding to the index i in the second probability distribution Q.

Specifically, if each of the first probability distribution P and the second probability distribution Q is modelized as a histogram, i represents an index of a bin in the histogram of each of the first and second probability distributions P and Q, Pᵢ represents the height, i.e. the probability, of a normalized bin with the index i in the histogram of the first probability distribution P, and Qᵢ represents the height, i.e. the probability, of a normalized bin with the index i in the histogram of the second probability distribution Q.

The parameter estimator 32 can be configured to express the first probability distribution P using a first continuous probability distribution model defined based on the first parameters, and the second probability distribution Q using a second continuous probability distribution model defined based on the second parameters.

Specifically, the parameter estimator 32 is configured to express each of the first and second probability distributions P and Q using a gaussian mixture model (GMM). That is, the parameter estimator 32 estimates, as the first parameters, parameters obtained when the first probability distribution P is expressed based on the GMM, and also estimates, as the second parameters, parameters obtained when the second probability distribution Q is expressed based on the GMM.

Then, the inter-model evaluator 33 calculates a KL divergence as the dissimilarity level between the GMM of the first probability distribution P and the GMM of the second probability distribution Q.

Expressing each of the first probability distribution P and the second probability distribution Q as the GMM enables the KL divergence to be represented by the following equation (3):

$$KL ( P \vert \vert Q ) = P ( x ) \int ln \frac{p ( x )}{q ( x )} dx \qquad ( 3 )$$

where:

KL (P∥Q) represents the KL divergence;

Pₓ represents a probability of a variable x in the GMM defined based on the first parameters; and

Qₓ represents a probability of a variable x in the GMM defined based on the second parameters.

### Advantageous Effects

The second embodiment described above achieves the following advantageous effects in addition to those that are the same as those achieved by the first embodiment.

Specifically, the anomaly detection apparatus 100 according to the second embodiment is configured to express

(1) Express the first probability distribution P using a statistical model that is defined based on parameters indicative of the first probability distribution P if the parameters are

(2) Express the second probability distribution Q using a statistical model that is defined based on parameters indicative of the second probability distribution Q

This enables each of the first and second distributions P and Q to be expressed based on a statistical model with higher accuracy, making it possible to obtain the anomaly level of the road condition with higher accuracy.

Expressing each of the first and second distributions P and Q based on a histogram as an example of such a statistical model enables the features to be processed faster when a large amount of driving data items are successively collected so that the features are successively calculated.

Expressing each of the first and second distributions P and Q based on a histogram may result in the number of samples required to obtain the anomaly level of the road condition with high accuracy increasing exponentially with an increase of the number of dimensions of each reference data sample and evaluation data sample.

In contrast, expressing each of the first and second distributions P and Q based on a GMM enables the anomaly level of the road condition with relatively high accuracy while maintaining a relatively smaller number of samples required to obtain the anomaly level of the road condition as compared with a case where each of the first and second distributions P and Q is expressed based on a histogram.

### Modifications

The first and second embodiments of the present disclosure have been described, but the present disclosure is not limited to the above embodiments, and can be variably modified.

Each of the first and second embodiments configures at least a predetermined number of evaluation data samples for each attribute data item as an evaluation data set for the corresponding attribute data item, but the present disclosure is not limited thereto. Specifically, each of the first and second embodiments can configure a number of evaluation data samples for each attribute data item collected within a predetermined collection period as an evaluation data set for the corresponding attribute data item. The predetermined collection period can be set to, for example, 20 minutes, and a collection period for which reference data samples for each attribute data item are collected can be set to, for example, one week.

Each of the first and second embodiments is configured to send the vehicle signals from the collection unit 10 of each vehicle V to the detection server 20, but the present disclosure is not limited thereto. Specifically, the present disclosure can be configured to send the at least one feature from the collection unit 10 of each vehicle V to the detection server 20. That is, the collection unit 10 of each vehicle V can be comprised of the feature calculator 22, and the feature calculator 22 installed in the collection unit 10 of each vehicle V is configured to send, to the detection server 20, the at least one feature correlating to one or more attribute data items.

The driving data items collected by each of the collection units 10 can be stored in the reference DB 23 and the evaluation DB 24, and each of the anomaly level calculators 30 and 30A can serve as the feature calculator 22.

Each of the first and second embodiments can use, as the features, driving topic proportions, which are disclosed in Japanese Patent Publication No. 6026959. The disclosure of Japanese Patent Publication No. 6026959 is incorporated entirely herein by reference.

The functions of one element in each of the first and second embodiments can be distributed as plural elements, and the functions that plural elements have can be combined into one element. At least part of the structure of each of the first and second embodiments can be replaced with a known structure having the same function as the at least part of the structure of the corresponding embodiment. A part of the structure of each of the first and second embodiments can be eliminated. At least part of the structure of each of the first and second embodiments can be added to or replaced with the structures of the other embodiment. All aspects included in the technological ideas specified by the language employed by the claims constitute embodiments of the present invention.

The present disclosure can be implemented by various embodiments in addition to the anomaly detection apparatus; the various embodiments include systems each including the anomaly detection apparatus, programs for serving a computer as the anomaly detection apparatus, storage media, such as non-transitory computer-readable storage media storing the programs, and anomaly detection methods.

While the illustrative embodiments of the present disclosure have been described herein, the present disclosure is not limited to the embodiments described herein, but includes any and all embodiments having modifications, omissions, combinations (e.g., of aspects across various embodiments), adaptations and/or alternations as would be appreciated by those having ordinary skill in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An apparatus for detecting an anomaly of an evaluation target condition of a road, the apparatus comprising:
a storage that stores a reference data set correlating to a predetermined attribute and being comprised of reference data samples, the reference data samples having been respectively collected from reference vehicles as reference driving data items at the predetermined attribute under a normal condition of the road, the reference driving data item for each of the reference vehicles representing at least one driving operation of the corresponding one of the reference vehicles; and
an anomaly level calculator configured to:
obtain, from target vehicles, an evaluation data set correlating to the predetermined attribute and being comprised of evaluation data samples, the evaluation data samples being collected from the respective target vehicles as target driving data items at the predetermined attribute under the evaluation target condition of the road, the target driving data item for each of the target vehicles representing at least one driving operation of the corresponding one of the target vehicles; and
compare the reference data set with the evaluation data set to thereby calculate an anomaly level of the evaluation target condition of the road.

2. The apparatus according to claim 1, wherein:
the anomaly level calculator is configured to:
generate a first probability distribution based on the reference data set;
generate a second probability distribution based on the evaluation data set; and
calculate, as the anomaly level, a dissimilarity level between the first probability distribution and the second probability distribution.

3. The apparatus according to claim 2, wherein:
the anomaly level calculator is configured to calculate the dissimilarity level between the first probability distribution and the second probability distribution in accordance with distances between the reference data samples included in the reference data set and respective evaluation data samples included in the evaluation data set.

4. The apparatus according to claim 3, wherein:
the anomaly level calculator is configured to calculate, as the dissimilarity level between the first probability distribution and the second probability distribution, two-sample U statistics designed as a sample approximation of the square of a maximum mean discrepancy.

5. The apparatus according to claim 3, wherein:
the anomaly level calculator is configured to calculate, as the dissimilarity level between the first probability distribution and the second probability distribution, Kolmogorov-Smirnov statistics.

6. The apparatus according to claim 2, wherein:
the anomaly level calculator is configured to:
estimate a finite number of parameters defining a first statistical model of the first probability distribution as first parameters;
estimate a finite number of parameters defining a second statistical model of the second probability distribution as second parameters; and
calculate a dissimilarity level between the first and the second statistical models as the dissimilarity level between the first and second probability distributions.

7. The apparatus according to claim 6, wherein:
the anomaly level calculator is configured to express each of the first and second statistical models as a histogram.

8. The apparatus according to claim 6, wherein:
the anomaly level calculator is configured to express each of the first and second statistical models as a gaussian mixture model.

9. A method of detecting an anomaly of an evaluation target condition of a road, the method comprising:
preparing a reference data set correlating to a predetermined attribute and being comprised of reference data samples, the reference data samples having been respectively collected from reference vehicles as reference driving data items at the predetermined attribute under a normal condition of the road, the reference driving data item for each of the reference vehicles representing at least one driving operation of the corresponding one of the reference vehicles; and
obtaining, from target vehicles, an evaluation data set correlating to the predetermined attribute and being comprised of evaluation data samples, the evaluation data samples being collected from the respective target vehicles as target driving data items at the predetermined attribute under the evaluation target condition of the road, the target driving data item for each of the target vehicles representing at least one driving operation of the corresponding one of the target vehicles; and
comparing the reference data set with the evaluation data set to thereby calculate an anomaly level of the evaluation target condition of the road.
